(19) United States
(12) Patent Application Publication
(10) Pub. No.: US 2026/0183701 A1
(43) Pub. Date: Jul. 2, 2026

(54) DIRECT AIR CAPTURE SYSTEM AND METHOD

(71) Applicant: Equinor Low Carbon UK Limited, London (GB)

(72) Inventor: Gervas FRANCESCHINI, Derby (GB)

(21) Appl. No.: 19/128,856

(22) PCT Filed: Oct. 12, 2023
(86) PCT No.: PCT/EP2023/078376

§ 371 Date: May 9, 2025

(30) Foreign Application Priority Data
Nov. 10, 2022 (GB) 2216767.0

(51) Int. Cl. B01D 53/14; B01D 53/18

(52) U.S. Cl. CPC B01D 53/1475; B01D 53/1412; B01D 53/18; B01D 2257/504; B01D 2258/06

(57) ABSTRACT

A direct air capture (DAC) system includes a plurality of DAC units, spaced apart from each other. Each DAC unit of the plurality of DAC units includes at least one DAC module. The at least one DAC module includes a housing at least one absorber and at least one airflow unit. The at least one airflow unit generates an airflow unit that exits the at least one DAC module at an exit speed along an exit direction. The DAC system further includes a controller communicably coupled to the at least one airflow unit of the at least one DAC module. The controller is configured to control the airflow exiting the at least one DAC module to generate one or more wind eddies from a surrounding air.

### FIELD OF THE DISCLOSURE

The present disclosure relates to a direct air capture system, and a method of operating the direct air capture system.

### BACKGROUND

Greenhouse gases, such as, carbon dioxide (CO₂), are naturally occurring chemical compounds present in Earth's atmosphere. Increasing concentrations of greenhouse gases in the atmosphere has been a growing concern as they increase a risk of global warming. CO₂ is a by-product of combustion of hydrocarbon fuels used in plants and factories, which are primary emission sources. Systems and methods are being implemented around the world to reduce CO₂ from the atmosphere in an effort to achieve the goal of net zero emissions and reduce global warming.

Direct air capture (DAC) system is one such method to reduce the amount of CO₂ in the atmosphere. DAC system captures CO₂ from surrounding air and creates a concentrated CO₂ product stream that can be sold, utilized, upgraded, or sequestered underground. The DAC system uses a sorbent medium to capture CO₂ from the atmosphere. In order to capture large amounts of CO₂ from the atmosphere, DAC systems typically include a plurality of DAC units that may be installed in a spaced apart manner from each other. Each DAC unit treats air to reduce CO₂ from the air such that CO₂ depleted air exits the corresponding DAC unit. Typically, the CO2 depleted air exiting an upstream DAC unit is directed towards a downstream DAC unit. If the CO₂ depleted air is directly introduced into the downstream DAC unit, the downstream unit may not be used to its full capacity as the CO₂ depleted air already contains low amounts of CO₂. This phenomenon may decrease an efficiency of the DAC system.

In some cases, the DAC units may have to be separated from each other by a substantial distance for the downstream DAC unit to receive air that near normal atmospheric concentrations of CO₂. Such a separation distance may be hundreds of times of a height of the DAC units. This technique may impose a dilemma on the design of the DAC system as a large footprint of the DAC system may not be desirable. Therefore, it may be desirable to have a technique that facilitates usage of the DAC system to their full capacity for separating CO₂ from the atmosphere and also increases the efficiency of the DAC system.

### SUMMARY

According to a first aspect, there is provided a direct air capture (DAC) system. The DAC system includes a plurality of DAC units spaced apart from each other. Each DAC unit of the plurality of DAC units includes at least one DAC module. The at least one DAC module includes a housing, at least one absorber disposed within the housing, and at least one airflow unit mounted to the housing. The at least one airflow unit generates an airflow that exits the at least one DAC module at an exit speed along an exit direction. The airflow flows towards a downstream DAC unit of the plurality of DAC units. The DAC system further includes a controller communicably coupled to the at least one airflow unit of the at least one DAC module. The controller is configured to control the airflow exiting the at least one DAC module to generate one or more wind eddies from a surrounding air.

The at least one absorber associated with the at least one DAC module may absorb carbon dioxide (CO₂) from the airflow such that the airflow exiting a particular DAC unit has lower levels of CO₂. The extracted CO₂ may be collected to produce fuel for aircrafts or automobiles, ceramics, carbonated drinks, and the like. Further, the one or more wind eddies may create a large-scale dynamic flow structure that may cause a mixing of the airflow exiting the at least one DAC module with the surrounding air present downstream of a particular DAC unit. The mixing of the CO₂ depleted airflows with the surrounding air may prevent ingestion of air containing low amounts of CO₂ into the downstream DAC unit and may direct substantially fresh air with near normal atmospheric concentrations of CO₂ into the downstream DAC unit. Thus, the mixing of the airflows with the surrounding air may allow the downstream DAC unit to capture higher quantities of CO₂ which may allow usage of the DAC system to its full capacity and may also increase an efficiency of the DAC system.

In some embodiments, the at least one DAC module includes a plurality of DAC modules disposed adjacent to each other. The controller is further configured to control the at least one airflow unit of each of the plurality of DAC modules to independently vary the exit speed of the airflow, such that the exit speed of the airflow of one DAC module of the plurality of DAC modules is different from the exit speed of the airflow of at least one other DAC module of the plurality DAC modules. Additionally, or optionally, the controller is further configured to control the at least one airflow unit of each of the plurality of DAC modules to independently vary the exit direction of the airflow, such that the exit direction of the airflow of the one DAC module is different from the exit direction of the airflow of the other DAC module of the plurality DAC modules. Such a variation in the exit speeds and/or the exit directions of the airflows may create the large-scale flow structure which may promote the mixing of the airflows exiting the plurality of DAC modules with the surrounding air.

In some embodiments, the at least one airflow unit includes a fan configured to operate at a fan speed and generate the airflow, and a diverter configured to vary the exit direction of the airflow. The controller is further configured to independently vary the fan speed of the fan of the at least one airflow unit of each DAC module to vary the exit speed of the airflow, such that the fan speed of fan of the one DAC module is different from the fan speed of the fan of the at least one other DAC module. Additionally, or optionally, the controller is further configured to independently actuate the diverter of the at least one airflow unit of each DAC module in order to vary the exit direction of the airflow, such that the exit direction of the airflow of the one DAC module is different from the exit direction of the airflow of the at least one other DAC module. The variation in the fan speed of the DAC modules may cause a variation in the exit speed of the airflow which may in turn create the large-scale flow structure and may promote the mixing of the airflow exiting the plurality of DAC modules with the surrounding air. Further, the actuation of the diverter may cause variation in the exit direction of the airflow which may in turn create the large-scale flow structure and may promote the mixing of the airflow exiting the plurality of DAC modules with the surrounding air.

In some embodiments, the DAC system further includes at least one first sensor communicably coupled to the controller and configured to determine at least one wind parameter of a wind downstream of each DAC unit. The controller is further configured to independently vary the fan speed of the fan of the at least one airflow unit of each DAC module and/or independently actuate the diverter of the at least one airflow unit of each DAC module based on the at least one wind parameter. Thus, the determination of the at least one wind parameter by the first sensor may be used to control the fan speed and/or the diverter in order to optimize the airflows exiting the DAC modules so as to promote the mixing of the airflows with the surrounding air present downstream of the DAC unit.

In some embodiments, the at least one wind parameter includes a wind direction, a wind speed, and/or a wind pressure. The determination of the wind direction, the wind speed, and/or the wind pressure may be used to control the fan speed and/or the diverter in order to optimize the airflows exiting the DAC modules which may ultimately improve a performance of the DAC system.

In some embodiments, the at least one first sensor includes an anemometer. The anemometer may be used to measure the wind speed at a downstream end of each upstream DAC unit of the DAC system.

In some embodiments, the DAC system further includes at least one second sensor communicably coupled to the controller and configured to determine a CO₂ concentration in an air upstream of the downstream DAC unit. The controller is further configured to independently vary the fan speed of the fan of the at least one airflow unit of each DAC module and/or independently actuate the diverter of the at least one airflow unit of each DAC module based on the CO₂ concentration. The determination of the CO₂ concentration in the air upstream of the downstream DAC unit may allow the controller to vary the fan speed and/or actuate the diverter to promote mixing of the airflows exiting the upstream DAC unit with the surrounding air. For example, if the CO₂ concentration is low, the exit speeds and the exit directions of the airflows may be accordingly adjusted so that the CO₂ concentration in the air upstream of the downstream DAC unit increases based on the mixing.

In some embodiments, the diverter includes a louver. The controller is further configured to move the louver in order to vary the exit direction of the airflow. The controller may adjust a position of the louver in order to vary the exit direction of the airflow, thereby directing substantially fresh air with near normal atmospheric concentrations of CO₂ into the downstream DAC unit.

In some embodiments, the diverter includes a cowl of the fan. The controller is further configured to move the cowl of the fan in order to vary the exit direction of the airflow. The controller may move the cowl of the fan in order to vary the exit direction of the airflow, thereby directing substantially fresh air with near normal atmospheric concentrations of CO₂ into the downstream DAC unit.

In some embodiments, the plurality of DAC modules of each DAC unit are arranged in an array comprising a plurality of rows and a plurality of columns. The plurality of DAC modules arranged in the array together with the independent control of the airflows exiting the DAC modules may promote mixing of the airflows with the surrounding air present downstream of the DAC unit in order to direct substantially fresh air with near normal atmospheric concentrations of CO₂ into the downstream DAC unit. Further, the plurality of DAC modules arranged in the array may also allow capture of increased amounts of CO₂ from the flow of surrounding air passing through the DAC modules.

In some embodiments, the controller is configured to control the airflow exiting the at least one DAC module to generate the one or more wind eddies on a scale of a spacing between two adjacent DAC units from the plurality of DAC units. Specifically, the controller may be programmed so as to generate the one or more wind eddies based on the spacing between the two adjacent DAC units in order to allow sufficient mixing of the airflows with the surrounding air present downstream of the DAC unit.

In some embodiments, the plurality of DAC modules are coplanar with each other. The coplanar DAC modules together with the independent control of the airflows exiting the DAC modules may promote mixing of the airflows with the surrounding air present downstream of the DAC unit in order to direct substantially fresh air with near normal atmospheric concentrations of CO₂ into the downstream DAC unit.

In some embodiments, at least two of the plurality of DAC modules are inclined to each other. The at least two inclined DAC modules together with the independent control of the airflows exiting the DAC modules may promote mixing of the airflows with the surrounding air present downstream of the DAC unit in order to direct substantially fresh air with near normal atmospheric concentrations of CO₂ into the downstream DAC unit.

In some embodiments, at least two of the plurality of DAC modules define a gap between each other. For example, the at least two of the plurality of DAC modules may be laterally spaced apart from each other to define the gap. The DAC modules that are laterally spaced apart from each other together with the independent control of the airflows exiting the DAC modules may promote mixing of the airflows with the surrounding air present downstream of the DAC unit in order to direct substantially fresh air with near normal atmospheric concentrations of CO₂ into the downstream DAC unit.

In some embodiments, the plurality of DAC modules are arranged in a staggered arrangement. The DAC modules arranged in the staggered arrangement together with the independent control of the airflows exiting the DAC modules may promote mixing of the airflows with the surrounding air present downstream of the DAC unit in order to direct substantially fresh air with near normal atmospheric concentrations of CO₂ into the downstream DAC unit.

In some embodiments, at least two of the plurality of DAC modules have different heights. The at least two DAC modules having different heights together with the independent control of the airflows exiting the DAC modules may promote mixing of the airflows with the surrounding air present downstream of the DAC unit in order to direct substantially fresh air with near normal atmospheric concentrations of CO₂ into the downstream DAC unit.

In a second aspect, a method is provided. The method includes providing a plurality of DAC units spaced apart from each other. Each DAC unit of the plurality of DAC units includes at least one DAC module. The at least one DAC module includes a housing, at least one absorber disposed within the housing, and at least one airflow unit mounted to the housing. The at least one airflow unit generates an airflow that exits the at least one DAC module at an exit speed along an exit direction. The airflow flows towards a downstream DAC unit of the plurality of DAC units. The method further includes controlling, via the controller, the airflow exiting the at least one DAC module to generate one or more wind eddies from a surrounding air.

Further, the method teaches generation of the one or more wind eddies that may create a large-scale dynamic flow structure that may cause a mixing of the airflow exiting the at least one DAC module with the surrounding air. The mixing of the airflow (i.e., the CO₂ depleted airflows) with the surrounding air may prevent ingestion of air that contains low amounts of CO₂ into the downstream DAC unit and may direct substantially fresh air with near normal atmospheric concentrations of CO₂ into the downstream DAC unit. Thus, the mixing of the airflows with the surrounding air may allow the downstream DAC unit to capture higher quantities of CO₂ which may allow usage of the DAC system to its full capacity and may also increase an efficiency of the DAC system.

In some embodiments, the at least one DAC module comprises a plurality of DAC modules disposed adjacent to each other. The method further includes controlling, by the controller, the at least one airflow unit of each of the plurality of DAC modules to independently vary the exit speed of the airflow, such that the exit speed of the airflow of one DAC module of the plurality of DAC modules is different from the exit speed of the airflow of at least one other DAC module of the plurality DAC modules. Additionally, or optionally, the method further includes controlling, by the controller, the at least one airflow unit of each of the plurality of DAC modules to independently vary the exit direction of the airflow, such that the exit direction of the airflow of the one DAC module is different from the exit direction of the airflow of the other DAC module of the plurality DAC modules. Such a variation in the exit speeds and/or the exit directions of the airflows may create the large-scale flow structure and may promote the mixing of the airflows exiting the plurality of DAC modules with the surrounding air. In some embodiments, the at least one airflow unit comprises a fan configured to operate at a fan speed and generate the airflow, and a diverter configured to vary the exit direction of the airflow. The method further includes independently varying, via the controller, the fan speed of the fan of the at least one airflow unit of each DAC module to vary the exit speed of the airflow, such that the fan speed of the fan of the one DAC module is different from the fan speed of the fan of the at least one other DAC module. Additionally, or optionally, the method further includes independently actuating, via the controller, the diverter of the at least one airflow unit of each DAC module in order to vary the exit direction of the airflow, such that the exit direction of the airflow of the one DAC module is different from the exit direction of the airflow of the at least one other DAC module.

The variation in the fan speed of the fan of the DAC modules may cause a variation in the exit speeds of the airflows which may in turn create the large-scale flow structure and may promote the mixing of the airflows exiting the plurality of DAC modules with the surrounding air. Further, the actuation of the diverter may cause variation in the exit directions of the airflows which may in turn create the large-scale flow structure and may promote the mixing of the airflows exiting the plurality of DAC modules with the surrounding air.

In some embodiments, the method further includes determining, via at least one first sensor, at least one wind parameter of a wind downstream of each DAC unit. The fan speed of the fan of the at least one airflow unit of each DAC module is independently varied and/or the diverter of the at least one airflow unit of each DAC module is independently actuated based on the at least one wind parameter.

The determination of the at least one wind parameter by the first sensor may be used to control the exit speed and/or the exit direction in order to optimize the airflows exiting the DAC modules so as to promote the mixing of the airflows with the surrounding air present downstream of the DAC unit.

In some embodiments, the method further includes determining, via at least one second sensor, a CO₂ concentration in an air upstream of the downstream DAC unit. The fan speed of the fan of the at least one airflow unit of each DAC module is independently varied and/or the diverter of the at least one airflow unit of each DAC module is independently actuated based on the CO₂ concentration.

The determination of the CO₂ concentration in the air upstream of the downstream DAC unit may allow the controller to vary the fan speed and/or actuate the diverter to promote mixing of airflows with the surrounding air. For example, if the CO₂ concentration is low, the exit speeds and the exit directions of the airflows may be accordingly adjusted so that the CO₂ concentration in the air upstream of the downstream DAC unit increases based on the mixing of the airflows with the surrounding air.

In some embodiments, the method further includes mixing the airflows exiting the plurality of DAC modules by independently varying the fan speed of the fan of the at least one airflow unit of each DAC module and/or independently actuating the diverter of the at least one airflow unit of each DAC module. The independent variation in the fan speeds and/or the independent actuation of the diverters of the DAC modules may create the large-scale flow structure which may promote the mixing of the airflows exiting the plurality of DAC modules with the surrounding air present downstream of the DAC unit.

### BRIEF DESCRIPTION OF THE DRAWINGS

Embodiments will now be described by way of example only, with reference to the Figures, in which:

FIG. 1 is a schematic side view of a direct air capture (DAC) system, according to an embodiment of the present disclosure;

FIG. 2 is a schematic perspective view of a DAC unit of the DAC system of FIG. 1, according to an embodiment of the present disclosure;

FIG. 3 is a schematic block diagram of the DAC system of FIG. 1, according to an embodiment of the present disclosure;

FIG. 4 is a schematic block diagram of a DAC module associated with the DAC unit of FIG. 2, according to an embodiment of the present disclosure;

FIG. 5 is a schematic front view of an airflow unit associated with the DAC module of FIG. 4, according to an embodiment of the present disclosure;

FIG. 6A is a schematic block diagram of a DAC module that may be associated with the DAC unit of FIG. 2, according to another embodiment of the present disclosure;

FIG. 6B is a schematic block diagram of a DAC module that may be associated with the DAC unit of FIG. 2, according to yet another embodiment of the present disclosure;

FIG. 7 is a schematic block diagram of a control system associated with the DAC system of FIG. 1, according to an embodiment of the present disclosure;

FIG. 8 is a schematic front view of an airflow unit that may be associated with the DAC module of FIG. 4, according to another embodiment of the present disclosure; FIGS. 9A, 9B, and 9C are schematic perspective views of the DAC unit of FIG. 2 with different controls of airflows exiting the DAC modules of the DAC unit, according to an embodiment of the present disclosure;

FIGS. 10A, 10B, 10C are schematic perspective views of the DAC unit of FIG. 2 with different controls of airflows exiting the DAC modules of the DAC unit, according to another embodiment of the present disclosure;

FIG. 11A is a schematic top view of a DAC unit wherein two DAC modules are inclined relative to each other, according to an embodiment of the present disclosure;

FIG. 11B is a schematic top view of a DAC unit wherein a gap is defined between two DAC modules, according to another embodiment of the present disclosure;

FIG. 11C is a schematic top view of a DAC unit having two DAC modules arranged in a staggered arrangement, according to yet another embodiment of the present disclosure;

FIG. 11D is a schematic front view of a DAC unit having two DAC modules having different heights, according to an embodiment of the present disclosure; and

FIG. 12 is a flowchart illustrating a method of operating the DAC system of FIG. 1, according to an embodiment of the present disclosure.

### DETAILED DESCRIPTION

Aspects and embodiments of the present disclosure will now be discussed with reference to the accompanying Figures. Further aspects and embodiments will be apparent to those skilled in the art.

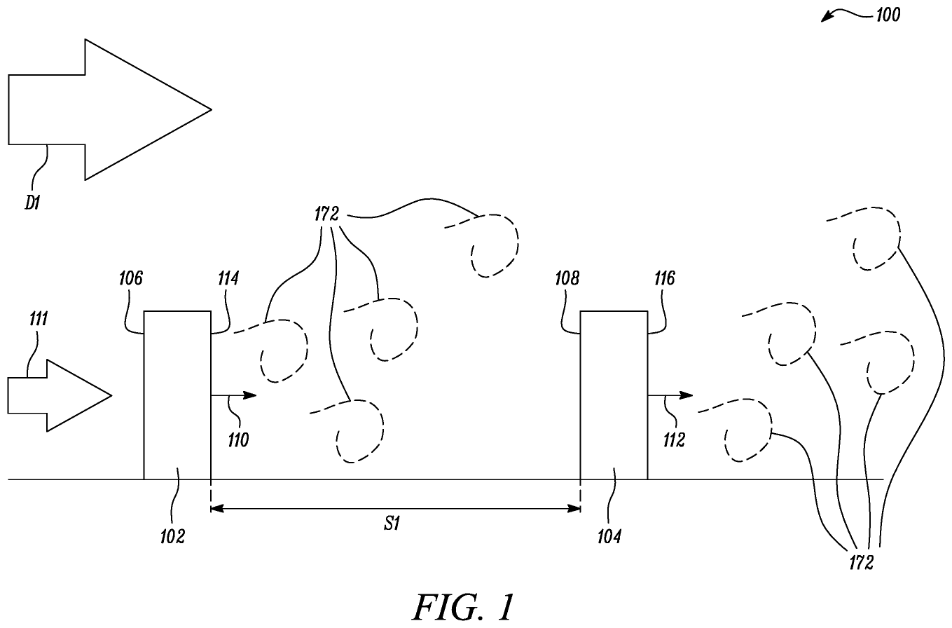

FIG. 1 shows a schematic side view of a direct air capture (DAC) system 100, according to an embodiment of the present disclosure. The DAC system 100 includes a plurality of DAC units 102, 104 spaced apart from each other. The DAC units 102, 104 are longitudinally spaced apart from each other. Further, the DAC unit 102 is separated from the DAC unit 104 by a spacing S1. The DAC unit 102 is embodied as an upstream DAC unit 104 and the DAC unit 104 is embodied as a downstream DAC unit 104. Although only two DAC units 102, 104 are illustrated herein, it should be noted that the DAC system 100 may include any number of DAC units that may be longitudinally and/or laterally spaced apart from each other. Further, the DAC units 102, 104 are identical to each other in design and functionality.

The DAC unit 102 is configured to receive a flow of inlet air 111 at its inlet end 106 such that the DAC unit 102 captures carbon dioxide (CO₂) from the inlet air 111 before the inlet air 111 exits as an airflow 110 at an outlet end 114 of the DAC unit 102. The airflow 110 flows towards the downstream DAC unit 104 of the plurality of DAC units 102, 104 (shown in FIG. 1). In some examples, at least a portion of the airflow 110 exiting the DAC unit 102 may be received by the downstream DAC unit 104. Accordingly, the DAC unit 104 is configured to receive a flow of inlet air at its inlet end 108 such that the DAC unit 104 captures CO₂ from the inlet air before the inlet air exits as an airflow 112 at an outlet end 116 of the DAC unit 104. The term “inlet air” as used throughout the disclosure relates to air with normal or relatively high concentrations of CO₂ entering the DAC units 102, 104. The term “airflow” as used throughout the disclosure relates to air that exits the DAC units 102, 104 with low or zero concentrations of CO₂.

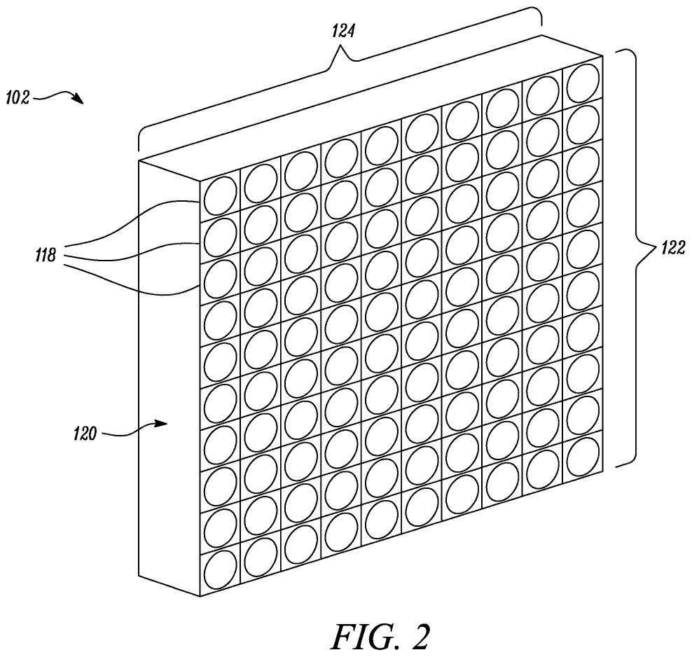

FIG. 2 shows a schematic perspective view of the DAC unit 102 of the DAC system 100 of FIG. 1, according to an embodiment of the present disclosure. As shown in FIG. 2, each DAC unit 102 of the plurality of DAC units 102, 104 (see FIG. 1) includes at least one DAC module 118. In the illustrated embodiment of FIG. 2, the at least one DAC module 118 includes a plurality of DAC modules 118 disposed adjacent to each other.

The plurality of DAC modules 118 of each DAC unit 102 are arranged in an array 120 including a plurality of rows 122 and a plurality of columns 124. The plurality of DAC modules 118 arranged in the array 120 may allow capture of increased amounts of CO₂ from the inlet air 111 passing through the DAC modules 118. In the illustrated embodiment of FIG. 2, the array includes ten rows 122 and ten columns 124. However, the array 120 may include any number of rows and columns, based on the application attributes. Further, in the illustrated embodiment of FIG. 2, the plurality of DAC modules 118 are coplanar with each other.

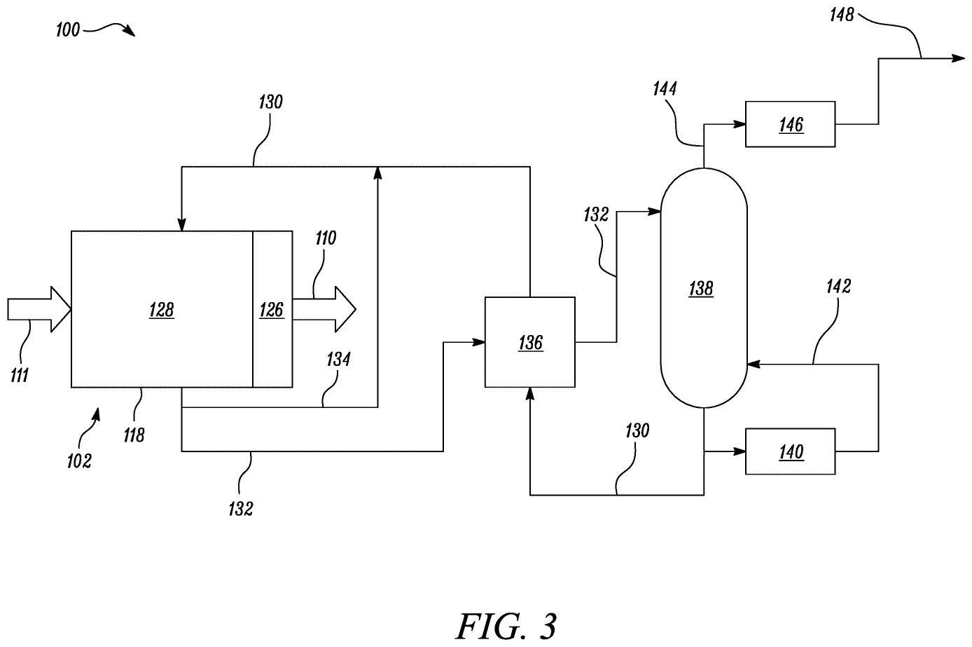

FIG. 3 shows a schematic block diagram of the DAC system 100 for capturing CO₂ from a CO₂ containing stream of gas. For the sake of simplicity, FIG. 3 will now be described in relation to treatment of the inlet air 111 flowing through the DAC unit 102. However, the description provided herein is equally applicable to treatment of inlet air flowing through the DAC unit 104 (see FIG. 1).

The DAC system 100 is embodied as a liquid-absorbent DAC system herein. Alternatively, the DAC system 100 may be embodied as a solid-absorbent DAC system that is conventionally known in the art. Further, the CO₂ containing stream of gas includes the inlet air 111 that enters the DAC unit 102. The at least one DAC module 118 includes at least one airflow unit 126. The at least one airflow unit 126 of the DAC module 118 generates the airflow 110 that exits the DAC module 118. Specifically, the inlet air 111 is received within the DAC module 118, the inlet air 111 is treated within the DAC module 118, and the inlet air 111 exits the DAC module 118 as the airflow 110 that has low levels of CO₂. Further, the at least one DAC module 118 includes at least one absorber 128. The at least one absorber 128 of the DAC module 118 receives the inlet air 111 therein. The absorber 128 absorbs at least a portion of the CO₂ present in the inlet air 111 flowing through the absorber 128. The inlet air 111 entering the absorber 128 undergoes an absorption process within the absorber 128. Moreover, the airflow 110 exits the absorber 128 after flowing through the absorber 128.

Further, a sorbent flows through the absorber 128 and interacts with the inlet air 111 received within the absorber 128. The sorbent may include any conventional sorbent that may absorb CO₂ from the inlet air 111. In some examples, the sorbent may be an aqueous potassium hydroxide solution or potassium carbonate. In the illustrated embodiment of FIG. 3, a lean stream 130 of the sorbent enters the absorber 128. The term “lean stream” as used throughout the disclosure relates to a stream of the sorbent that has low values of CO₂. The lean stream 130 contacts the inlet air 111 within the absorber 128 and absorbs CO₂ therefrom to become a rich stream 132. The term “rich stream” as used throughout the disclosure relates to a stream of the sorbent that has high values of CO₂. The lean stream 130 is converted to the rich stream 132 based on the absorption of CO₂ from the inlet air 111 flowing through the absorber 128. Further, a recirculation stream 134 of the sorbent may be recirculated within the absorber 128. The recirculation stream 134 may increase an effective residence time of each portion of the lean stream 130 of the sorbent in the absorber 128.

Further, the DAC system 100 includes a heat exchanger 136. The rich stream 132 passes through the heat exchanger 136 to recover heat from the lean stream 130 returning from a desorber 138 of the DAC system 100. Based on the heat exchange at the heat exchanger 136, a temperature of the rich stream 132 exiting the heat exchanger 136 is slightly increased. Further, the desorber 138 receives the rich stream 132 from the heat exchanger 136 and heats it up to a temperature that causes CO₂ to be released form the rich stream 132. The DAC system 100 further includes a heating means 140. The heating means 140 is embodied as a reboiler herein. The heating means 140 increases the temperature of the rich stream 132 by circulating a heated stream 142 of the sorbent through the desorber 138. Specifically, the heating means 140 receives a portion of the lean stream 130 exiting the desorber 138. Further, the heating means 140 heats the lean stream 130 to form the heated stream 142 that is introduced in the desorber 138. The heating means 140 may also generate steam to form vapour bubbles into which the desorbed CO₂ can diffuse, leaving the lean stream 130 of the sorbent to return to the absorber 128 to repeat the process. Further, a mixture 144 of the vapour and desorbed CO₂ exits the desorber 138. The DAC system 100 further includes a condenser 146 in fluid communication with the desorber 138. The condenser 146 receives the mixture 144 of the vapour and desorbed CO₂ from the desorber 138 and may cool the mixture 144 causing the vapour to condense leaving a CO₂ product stream 148. The CO₂ product stream 148 may be collected to produce fuel for aircrafts or automobiles, ceramics, carbonated drinks, and the like.

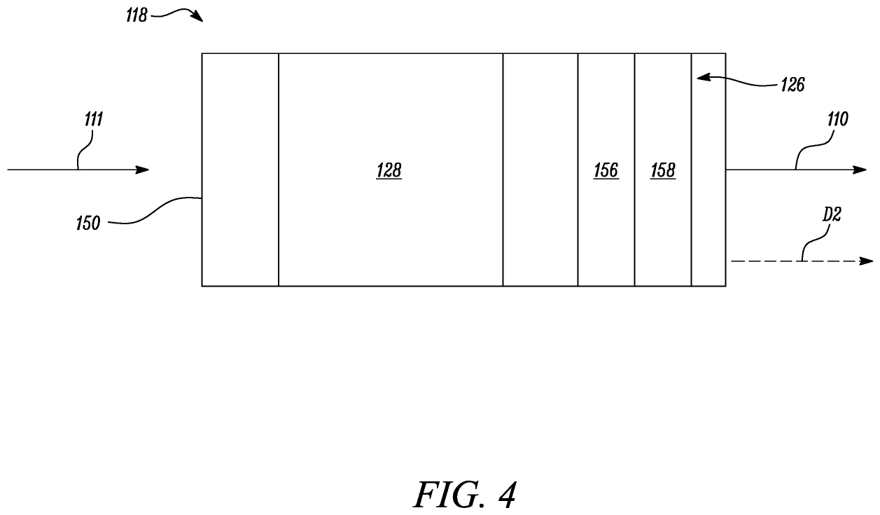

FIG. 4 is a schematic view of the DAC module 118 associated with the DAC unit 102, according to an embodiment of the present disclosure. It should be noted that each DAC module 118 associated with the DAC unit 102 may be identical in design. However, in some examples, the DAC modules 118 may have different designs. The at least one DAC module 118 includes a housing 150. In some examples, the housing 150 may be made of a polymeric material, a ceramic material, a metallic material, or a combination thereof. The at least one DAC module 118 further includes the at least one absorber 128 disposed within the housing 150. In some examples, the at least one absorber 128 may be embodied as a hollow structure disposed within the housing 150 that is configured to receive the inlet air 111 and the lean stream 130 (see FIG. 3) therein. In other examples, the absorber 128 may be defined by the housing 150 itself.

The at least one DAC module 118 further includes the at least one airflow unit 126 mounted to the housing 150. The at least one airflow unit 126 generates the airflow 110 that exits the at least one DAC module 118 at an exit speed along an exit direction D2. The at least one airflow unit 126 includes a fan 156 configured to operate at a fan speed and generate the airflow 110. The fan 156 may include a plurality of blades (not shown) that may be rotated by withdrawing power from a motor (not shown). The at least one airflow unit 126 further includes a diverter 158 configured to vary the exit direction D2 of the airflow 110.

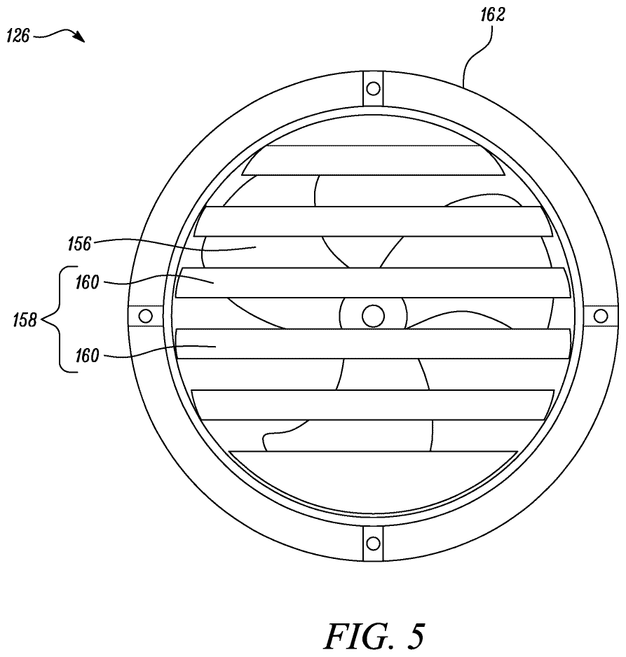

FIG. 5 shows a schematic front view of the airflow unit 126 associated with the DAC module 118 of FIG. 4, according to an embodiment of the present disclosure. In the illustrated embodiment of FIG. 5, the diverter 158 includes a louver 160. Specifically, the diverter 158 may include a plurality of louvers 160 spaced apart from each other along a vertical direction. In some examples, each louver 160 may be movable to vary the exit direction D2 of the airflow 110 (shown in FIG. 4). For example, an angle of the louvers 160 may be varied in order to vary the exit direction D2 of the airflow 110. Further, the airflow unit 126 may also include a cowl 162. The cowl 162 may be embodied as a housing to which the fan 156 may be mounted.

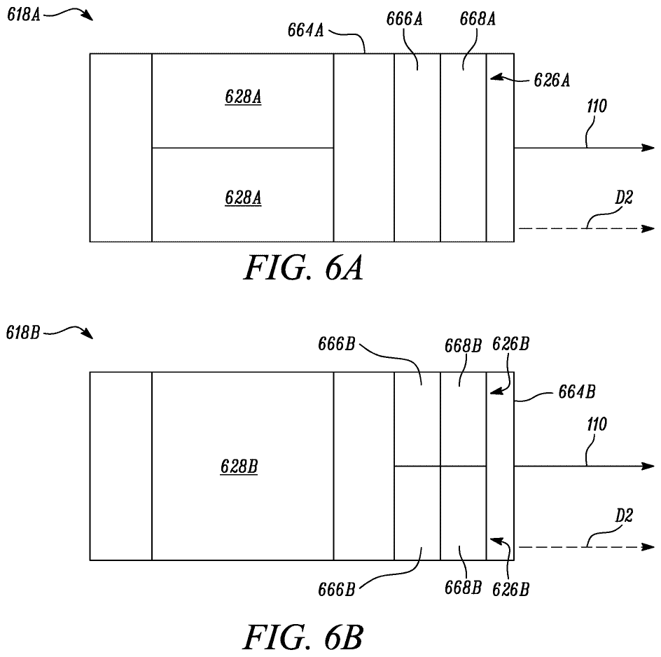

FIG. 6A shows a schematic view of a DAC module 618A that may be associated with the DAC unit 102 of FIG. 2, according to another embodiment of the present disclosure. The DAC module 618A illustrated in FIG. 6A is functionally similar to the DAC module 118 illustrated in FIG. 4. However, the DAC module 618A includes a pair of absorbers 628A disposed in a housing 664A. Further, the DAC module 618A includes a single airflow unit 626A for generating the airflow 110 that exits the DAC module 618A at the exit speed along the exit direction D2. The single airflow unit 626A includes a fan 666A configured to operate at a fan speed and generate the airflow 110. The single airflow unit 626A further includes a diverter 668A configured to vary the exit direction D2 of the airflow 110.

FIG. 6B shows a schematic view of a DAC module 618B of the DAC unit 102 of FIG. 2, according to another embodiment of the present disclosure. The DAC module 618B illustrated in FIG. 6B is functionally similar to the DAC module 118 illustrated in FIG. 4. However, the DAC module 618B includes a pair of airflow units 626B for generating the airflow 110 that exits the DAC module 618B at the exit speed along the exit direction D2. Further, each airflow unit 626B includes a corresponding fan 666B configured to operate at a fan speed and generate the airflow 110. In some examples, each fan 666B of the pair of airflow units 626B may be operated at different fan speeds in order to vary the exit speed of the airflow 110. Moreover, each airflow unit 626B includes a corresponding diverter 668B configured to vary the exit direction D2 of the airflow 110. In some examples, each diverter 668B of the pair of airflow units 626B may be positioned in a different manner in order to vary the exit direction D2 of the airflow 110. For example, the exit direction D2 of the airflow 110 exiting one of the airflow units 626B may be oblique related to the exit direction D2 of the airflow 110 exiting the other airflow unit 626B. Further, the DAC module 618B includes a single absorber 628B disposed in a housing 664B.

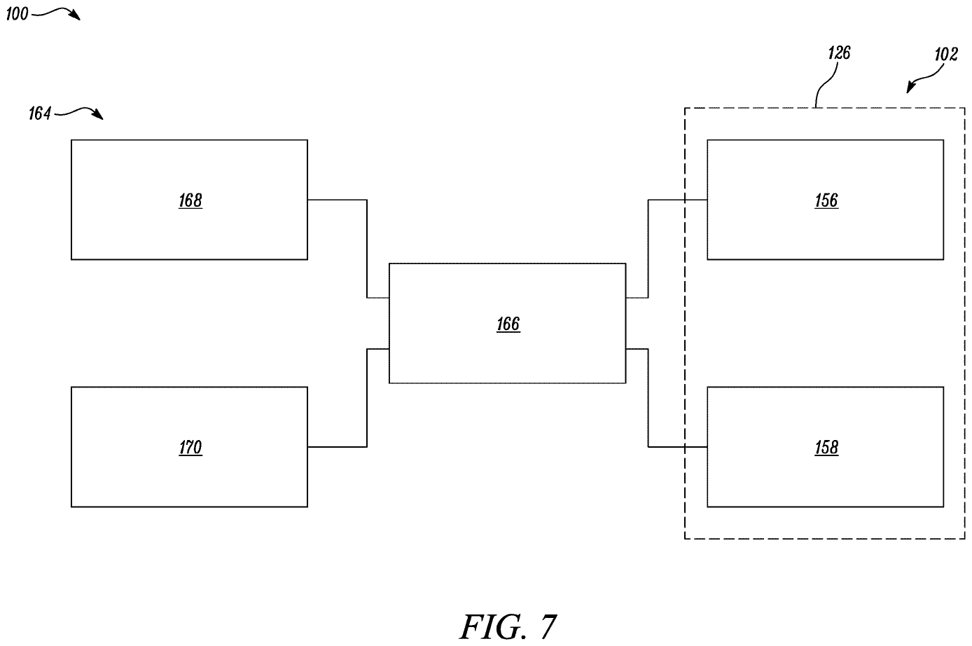

FIG. 7 shows a schematic block diagram of a control system 164 associated with the DAC system 100 of FIG. 1. In some examples, each DAC unit 102 of the DAC system 100 may include a corresponding control system 164. Alternatively, the control system 164 may be used to control each DAC unit 102, 104 (see FIG. 1) of the DAC system 100. As shown in FIG. 7, the DAC system 100 includes a controller 166. Particularly, the control system 164 includes the controller 166.

The controller 166 may include one or more processors and one or more memories. It should be noted that the one or more processors may embody a single microprocessor or multiple microprocessors for receiving various input signals. Numerous commercially available microprocessors may be configured to perform the functions of the one or more processors. Each processor may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor may include one or more components that may be operable to execute computer executable instructions or computer code that may be stored and retrieved from the one or more memories.

The control system 164 will now be described in relation to FIGS. 1, 4, 5, and 7. Referring to FIGS. 1, 4, 5, and 7, the controller 166 is communicably coupled to the at least one airflow unit 126 of the at least one DAC module 118. The controller 166 is configured to control the airflow 110 exiting the at least one DAC module 118 to generate one or more wind eddies 172 from a surrounding air. The DAC unit 102 includes the plurality of DAC modules 118 and the controller 166 may be configured to control the airflow 110 exiting each of the plurality of DAC modules 118 to generate the one or more wind eddies 172 from the surrounding air. The one or more wind eddies 172 may cause mixing of the airflows 110 exiting the plurality of DAC modules 118 with the surrounding air at the outlet end 114 of the DAC unit 102. The present disclosure will now be explained in relation to the control of the airflows 110 exiting the plurality of DAC modules 118 of the DAC unit 102.

Further, the one or more wind eddies 172 may create a large-scale dynamic flow structure that may cause a mixing of the airflow 110 exiting the at least one DAC module 118 with the surrounding air downstream of the DAC unit 102. The mixing of the airflow 110 (i.e., CO₂ depleted air) with the surrounding air may prevent ingestion of air containing low amounts of CO₂ in the downstream DAC unit 104 and may direct substantially fresh air with near normal atmospheric concentrations of CO₂ into the downstream DAC unit 104. Accordingly, the mixing of the airflow 110 with the surrounding air may allow the downstream DAC unit 104 to capture higher quantities of CO₂ which may allow usage of the DAC system 100 to its full capacity and may also increase an efficiency of the DAC system 100.

In some embodiments, the controller 166 is configured to control the at least one airflow unit 126 of each of the plurality of DAC modules 118 to independently vary the exit speed of the airflow 110, such that the exit speed of the airflow 110 of one DAC module 118 of the plurality of DAC modules 118 is different from the exit speed of the airflow 110 of at least one other DAC module 118 of the plurality DAC modules 118. Specifically, in some embodiments, the controller 166 is configured to independently vary the fan speed of the fan 156 of the at least one airflow unit 126 of each DAC module 118 to vary the exit speed of the airflow 110, such that the fan speed of the fan 156 of the one DAC module 118 is different from the fan speed of the fan 156 of the at least one other DAC module 118. The controller 166 may control the motor of a corresponding fan 156 to vary the fan speed. In some examples, the controller 166 may occasionally stop one or more fans 156 of a corresponding DAC module 118 in order to provide a dynamic integrated flow structure.

In some embodiments, the controller 166 is further configured to control the at least one airflow unit 126 of each of the plurality of DAC modules 118 to independently vary the exit direction D2 of the airflow 110, such that the exit direction D2 of the airflow 110 of the one DAC module 118 is different from the exit direction D2 of the airflow 110 of the other DAC module 118 of the plurality DAC modules 118. In some embodiments, the controller 166 is configured to independently actuate the diverter 158 of the at least one airflow unit 126 of each DAC module 118 in order to vary the exit direction D2 of the airflow 110, such that the exit direction D2 of the airflow 110 of the one DAC module 118 is different from the exit direction D2 of the airflow 110 of the at least one other DAC module 118. For example, the diverters 158 of the plurality of DAC modules 118 may be disposed such that the exit direction D2 of the airflow 110 exiting one of the airflow units 126 may be oblique related to the exit direction D2 of the airflow 110 exiting the other airflow unit 126. Thus, the arrangement of the plurality of DAC modules 118 in the array 120 together with the independent control of the airflows 110 exiting the DAC modules 118 may promote mixing of the airflows 110 with the surrounding air to direct substantially fresh air with near normal atmospheric concentrations of CO₂ into the downstream DAC unit 104.

In some embodiments, the controller 166 is configured to control the airflow 110 exiting the at least one DAC module 118 to generate the one or more wind eddies 172 on a scale of the spacing S1 between two adjacent DAC units 102, 104 from the plurality of DAC units 102, 104. Specifically, the controller 166 may be programmed so as to generate the one or more wind eddies 172 based on the spacing S1 between the two adjacent DAC units 102, 104 in order to allow sufficient mixing of the airflows 110 exiting the DAC modules 118 with the surrounding air. The wind eddies generated may have a mixing length of a similar size to the spacing between the adjacent DAC units. The mixing length may be between one and two times the spacing. The mixing length may be between half and one times the spacing. The mixing length may be between half and two times the spacing between the DAC units. The mixing length may cause the mixing of air flow above the DAC units with the air expelled from the DAC units over a vertical height corresponding to the mixing length.

In some embodiments, the DAC system 100 also includes at least one first sensor 168 communicably coupled to the controller 166. The at least one first sensor 168 is configured to determine at least one wind parameter of the wind downstream of each DAC unit 102. In some examples, the at least one wind parameter includes a wind direction D1 (see FIG. 1), a wind speed, and/or a wind pressure. In some examples, the at least one first sensor 168 includes an anemometer. The anemometer may be used to measure the wind speed at the outlet end 114, 116 of each DAC unit 102, 104.

In some embodiments, the controller 166 is configured to independently vary the fan speed of the fan 156 of the at least one airflow unit 126 of each DAC module 118 and/or independently actuate the diverter 158 of the at least one airflow unit 126 of each DAC module 118 based on the at least one wind parameter. For example, the controller 166 may be configured to independently vary the fan speed of the fan 156 and/or independently actuate the diverter 158 of the at least one airflow unit 126 of each DAC module 118 based on the wind direction D1, the wind speed, and/or the wind pressure measured by the at least one first sensor 168. Thus, the determination of the at least one wind parameter by the first sensor 168 may be used to control the fan speed and/or the diverter 158 in order to optimize the airflows 110 exiting the DAC modules 118 which may ultimately improve a performance of the DAC system 100.

In some embodiments, the DAC system 100 further includes at least one second sensor 170 communicably coupled to the controller 166. The at least one second sensor 170 is configured to determine a CO₂ concentration in an air upstream of the downstream DAC unit 104. In some examples, the at least one second sensor 170 may include a gas sensor. The determination of the CO₂ concentration in the air upstream of the DAC unit 104 may allow the controller 166 to vary the fan speed of the fan 156 and/or actuate the diverter 158 to promote mixing of airflows 110 with the surrounding air. Thus, the controller 166 may be configured to independently vary the fan speed of the fan 156 and/or independently actuate the diverter 158 of the at least one airflow unit 126 of each DAC module 118 based on the CO₂ concentration measured by the at least one second sensor 170.

In the embodiments illustrated on FIGS. 4, 5, and 7, the controller 166 is configured to move the louver 160 of each DAC module 118 in order to vary the exit direction D2 of the airflow 110, such that the exit direction D2 of the airflow 110 of the one DAC module 118 is different from the exit direction D2 of the airflow 110 of the other DAC module 118. The controller 166 may adjust a position of the louver 160 in order to vary the exit direction D2 of the airflow 110, to create eddies in the airflow above the DAC unit, thereby directing substantially fresh air with near normal atmospheric concentrations of CO₂ into the downstream DAC unit 104. The controller 166 may also move the louver such that all the modules in one DAC unit have the same exit direction. The exit direction D2 may be up to 45 degrees away from the horizontal direction.

FIG. 8 shows a schematic front view of an airflow unit 826 that may be associated with the DAC module 118 of FIG. 4, according to another embodiment of the present disclosure. The airflow unit 826 of FIG. 8 is substantially similar and functionally equivalent to the airflow unit 126 of FIGS. 4 and 5. The airflow unit 826 includes a cowl 862, a fan 856 mounted to the cowl 862, and a diverter 858. In the illustrated embodiment of FIG. 8, the diverter 858 of the airflow unit 826 is embodied as the cowl 862. In some examples, the cowl 862 may be movable to vary the exit direction D2 of the airflow 110. In such examples, the airflow unit 826 may omit the louvers. In some examples, it may be contemplated that the airflow units 826 includes a movable cowl as well as movable louvers. Referring to FIGS. 7 and 8, in some embodiments, the controller 166 is configured to move the cowl 862 of the airflow unit 826 in order to vary the exit direction D2 of the airflow 110, such that the exit direction D2 of the airflow 110 of the one DAC module 118 is different from the exit direction D2 of the airflow 110 of the other DAC module 118, or the exit direction of each module may be the same. The controller 166 may move the cowl 862 of the fan 856 in order to vary the exit direction D2 of the airflow 110, thereby directing substantially fresh air with near normal atmospheric concentrations of CO₂ into the downstream DAC unit 104.

FIGS. 9A, 9B, and 9C are schematic perspective views of the DAC unit 102 of FIG. 3 with different controls of airflows 110 exiting the DAC modules 118, according to an embodiment of the present disclosure. The DAC unit 102 includes multiple rows 902, 904, 906, such that each row 902, 904, 906 includes multiple DAC modules 118. As shown in FIG. 9A, the airflows 110 exiting the plurality of DAC modules 118 have different exit speeds as annotated by a length of the arrows representing the airflows 110. In the embodiment of FIG. 9A, at a first instant of time, the airflows 110 exiting the DAC modules 118 of the two adjacent rows 902 may have medium exit speeds. It should be noted that the airflows 110 exiting the DAC modules 118 of the two adjacent rows 902 may also vary relative to each other as depicted in FIG. 9A. Further, the airflows 110 exiting the DAC modules 118 of the three adjacent rows 904 may have low exit speeds that are lower than the exit speeds of the airflows 110 exiting the DAC modules 118 of the rows 902. It should be noted that the airflows 110 exiting the DAC modules 118 of the three adjacent rows 904 may also vary relative to each other as depicted in FIG. 9A. Furthermore, the airflows 110 exiting the DAC modules 118 of the five adjacent rows 906 may have high exit speeds that are higher than the exit speeds of the airflows 110 exiting the DAC modules 118 of the rows 902, 904. It should be noted that the airflows 110 exiting the DAC modules 118 of the five adjacent rows 906 may also vary relative to each other as depicted in FIG. 9A.

Similarly, as shown in FIG. 9B, at a second instant of time, the airflows 110 exiting the DAC modules 118 of the two adjacent rows 902 may have low exit speeds, the airflows 110 exiting the DAC modules 118 of the three adjacent rows 904 may have medium exit speeds that may be greater than the exit speeds of the airflows 110 exiting the DAC modules 118 of the rows 902, and the airflows 110 exiting the DAC modules 118 of the five adjacent rows 906 may have high exit speeds that are higher than the exit speeds of the airflows 110 exiting the DAC modules 118 of the rows 902, 904. Further, as shown in FIG. 9C, at a third instant of time, the airflows 110 exiting the DAC modules 118 of the two adjacent rows 902 may have low exit speeds, the airflows 110 exiting the DAC modules 118 of the three adjacent rows 904 may have high exit speeds that may be higher than the exit speeds of the airflows 110 exiting the DAC modules 118 of the rows 902, and the airflows 110 exiting the DAC modules 118 of the five adjacent rows 906 may have medium exit speeds that may be lesser than the exit speeds of the airflows 110 exiting the DAC modules 118 of the rows 902, but higher than the exit speeds of the airflows 110 exiting the DAC modules 118 of the rows 902. Although FIGS. 9A, 9B, and 9C illustrate variation of the exit speeds of the airflows 110 along a vertical direction, it may be contemplated that the exit speeds of the airflows 110 may also vary along a horizontal direction.

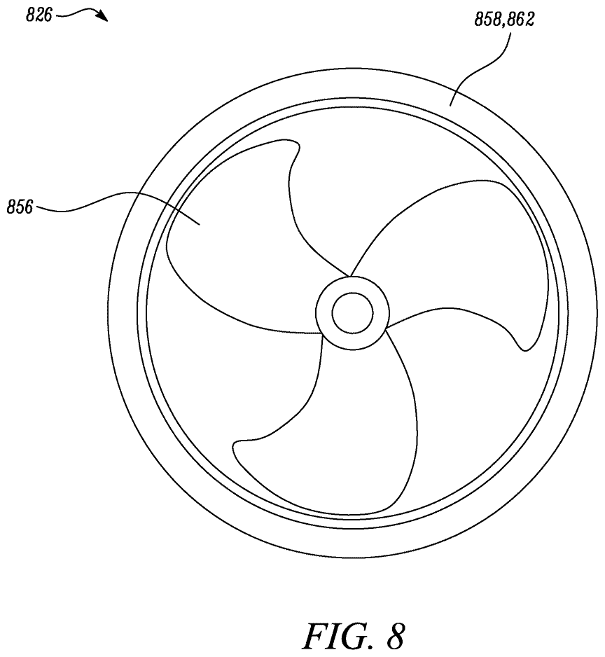

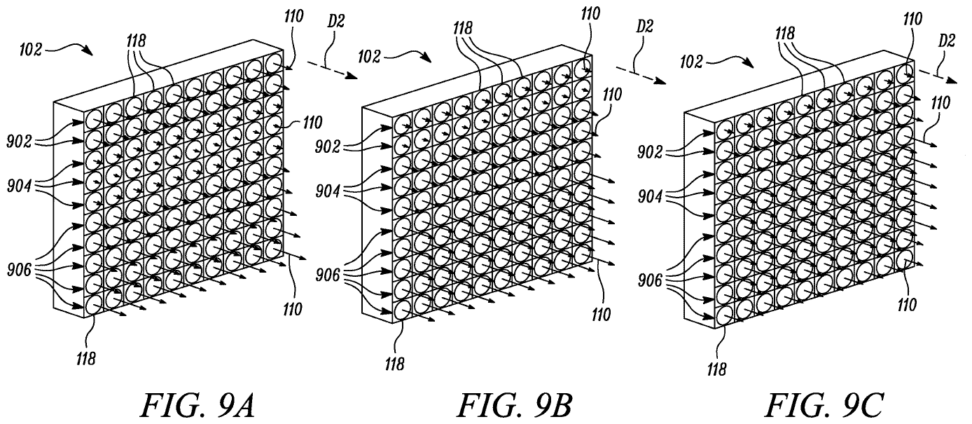

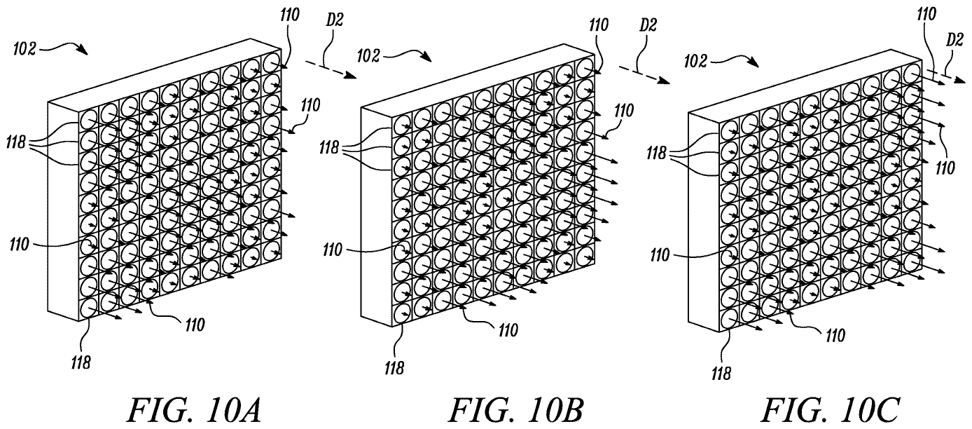

FIGS. 10A, 10B, and 10C are schematic perspective views of the DAC unit 102 of FIG. 3 with different controls of airflows 110 exiting the DAC modules 118, according to an embodiment of the present disclosure. As shown in FIGS. 10A, 10B, and 10C, the airflows 110 exiting the plurality of DAC modules 118 have different exit speeds as annotated by a length of the arrows representing the airflow 110. Further, the exit speeds of the airflows 110 vary in an arbitrary manner along the vertical direction as well as the horizontal direction.

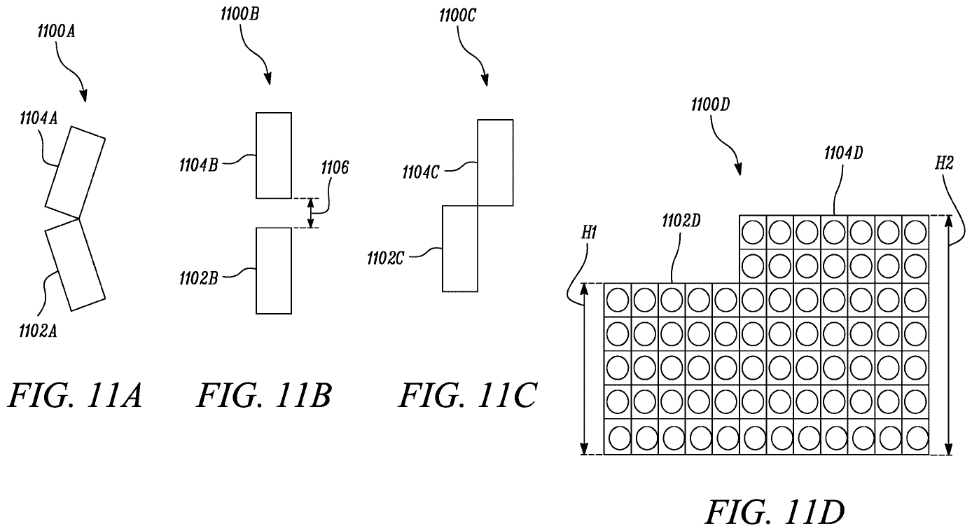

FIG. 11A shows a schematic top view of a DAC unit 1100A, according to an embodiment of the present disclosure. The DAC unit 1100A is substantially similar and functionally equivalent to the DAC system 100 (see FIG. 1). The DAC unit 1100A includes two DAC modules 1102A, 1104A that may be substantially similar and functionally equivalent to the DAC modules 118, 618A, 618B (see FIGS. 4, 6A, and 6B, respectively). However, in the DAC unit 1100A, at least two of the plurality of DAC modules 1102A, 1104A are inclined to each other. Although two DAC modules 1102A, 1104A have been illustrated herein, the DAC unit 1100A may have a first set having a plurality of DAC modules that may be inclined relative to a second set having a plurality of DAC modules. The at least two inclined DAC modules 1102A, 1104A together with the independent control of airflows exiting the DAC modules 1102A, 1104A may promote mixing of the airflows with the surrounding air to direct substantially fresh air with near normal atmospheric concentrations of CO₂ into a downstream DAC unit.

FIG. 11B shows a schematic top view of a DAC unit 1100B according to another embodiment of the present disclosure. The DAC unit 1100B is substantially similar and functionally equivalent to the DAC system 100 (see FIG. 1). The DAC unit 1100B includes two DAC modules 1102B, 1104B that may be substantially similar and functionally equivalent to the DAC modules 118, 618A, 618B (see FIGS. 4, 6A, and 6B, respectively). However, in the DAC unit 1100B, at least two of the plurality of DAC modules 1102B, 1104B define a gap 1106 between each other. Specifically, the DAC modules 1102B, 1104B are laterally spaced apart from each other to define the gap 1106 therebetween. Although two DAC modules 1102B, 1104B have been illustrated herein, the DAC unit 1100B may have a first set having a plurality of DAC modules that may be laterally spaced apart from a second set having a plurality of DAC modules. The DAC modules 1102B, 1104B that are laterally spaced apart from each other together with the independent control of airflows exiting the DAC modules 1102B, 1104B may promote mixing of the airflows with the surrounding air to direct substantially fresh air with near normal atmospheric concentrations of CO₂ into a downstream DAC unit.

FIG. 11C shows a schematic top view of a DAC unit 1100C according to another embodiment of the present disclosure. The DAC unit 1100C is substantially similar and functionally equivalent to the DAC system 100 (see FIG. 1). The DAC unit 1100C includes two DAC modules 1102C, 1104C that may be substantially similar and functionally equivalent to the DAC modules 118, 618A, 618B (see FIGS. 4, 6A, and 6B, respectively). However, in the DAC unit 1100C, at least two of the plurality of DAC modules 1102C, 1104C are arranged in a staggered arrangement. Specifically, the DAC modules 1102C, 1104C are disposed in an offset manner. Although two DAC modules 1102C, 1104C have been illustrated herein, the DAC unit 1100C may have a first set having a plurality of DAC modules and a second set having a plurality of DAC modules that may be arranged in a staggered arrangement. The DAC modules 1102C, 1104C arranged in the staggered arrangement together with the independent control of airflows exiting the DAC modules 1102C, 1104C may promote mixing of the airflows with the surrounding air to direct substantially fresh air with near normal atmospheric concentrations of CO₂ into a downstream DAC unit.

FIG. 11D shows a schematic front view of a DAC unit 1100D according to an embodiment of the present disclosure. The DAC unit 1100D is substantially similar and functionally equivalent to the DAC system 100 (see FIG. 1). The DAC unit 1100D includes two DAC modules 1102D, 1104D that may be substantially similar and functionally equivalent to the DAC modules 118, 618A, 618B (see FIGS. 4, 6A, and 6B, respectively). However, in the DAC unit 1100D, at least two of the plurality of DAC modules 1102D, 1104D have different heights H1, H2. Specifically, the height H2 of the DAC module 1104D is greater than the height H1 of the DAC module 1102D. Although two DAC modules 1102D, 1104D have been illustrated herein, the DAC unit 1100D may have a first set having a plurality of DAC modules and a second set having a plurality of DAC modules that may have different heights. The at least two DAC modules 1102D, 1104D having different heights H1, H2 together with the independent control of airflows exiting the DAC modules 1102D, 1104D may promote mixing of the airflows with the surrounding air to direct substantially fresh air with near normal atmospheric concentrations of CO₂ into a downstream DAC unit.

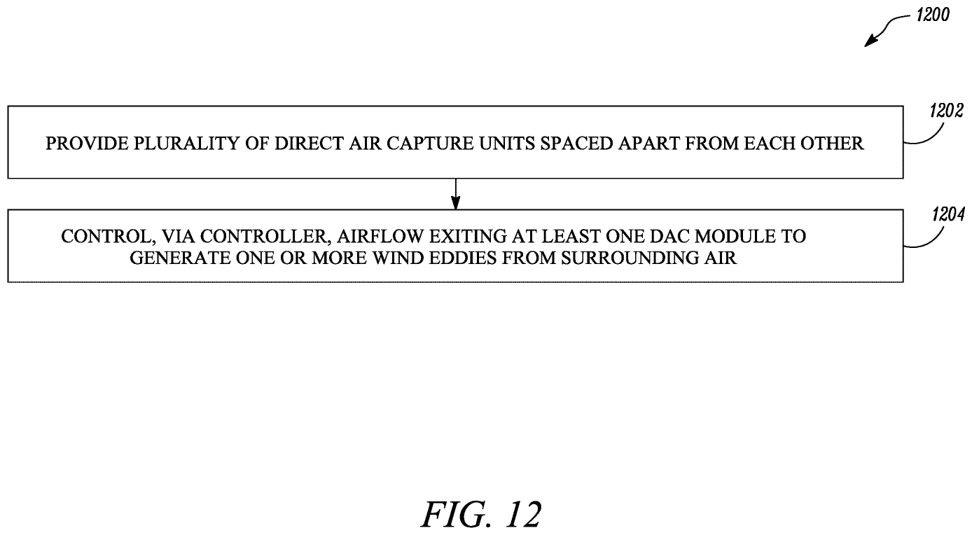

FIG. 12 is a flowchart illustrating a method 1200, according to an embodiment of the present disclosure. The method 1200 will now be explained in relation to the embodiments described in relation to FIGS. 1 to 5, 7, and 12. However, the method 1200 is equally applicable to other embodiments of this disclosure. With reference to FIGS. 1 to 5, 7, and 12, at a step 1202, the method 1200 includes providing the plurality of DAC units 102, 104 spaced apart from each other. Each DAC unit 102, 104 of the plurality of DAC units 102, 104 includes the at least one DAC module 118. The at least one DAC module 118 includes the housing 150, the at least one absorber 128 disposed within the housing 150, and the at least one airflow unit 126 mounted to the housing 150. The at least one airflow unit 126 generates the airflow 110 that exits the at least one DAC module 118 at the exit speed along the exit direction D2. The airflow 110 flows towards the downstream DAC unit 104 of the plurality of DAC units 102, 104. At step 1204, the method 1200 includes controlling, via the controller 166, the airflow 110 exiting the at least one DAC module 118 to generate the one or more wind eddies 172 from the surrounding air.

Further, the method 1200 teaches generation of the one or more wind eddies 172 that may create the large-scale dynamic flow structure which may cause the mixing of the airflow 110 exiting the at least one DAC module 118 with the surrounding air. The mixing of the airflow 110 (i.e., CO₂ depleted air) with the surrounding air may prevent ingestion of air containing low amounts of CO₂ into the downstream DAC unit 104 and may direct substantially fresh air with near normal atmospheric concentrations of CO₂ into the downstream DAC unit 104. Thus, the mixing of the airflow 110 with the surrounding air may allow the downstream DAC unit 104 to capture higher quantities of CO₂ which may allow usage of the DAC system 100 to its full capacity and may also increase an efficiency of the DAC system 100.

In some embodiments, the at least one DAC module 118 includes the plurality of DAC modules 118 disposed adjacent to each other. In some embodiments, the method 1200 further includes controlling, by the controller 166, the at least one airflow unit 126 of each of the plurality of DAC modules 118 to independently vary the exit speed of the airflow 110, such that the exit speed of the airflow 110 of one DAC module 118 of the plurality of DAC modules 118 is different from the exit speed of the airflow 110 of at least one other DAC module 118 of the plurality DAC modules 118. In some embodiments, the method 1200 further includes controlling, by the controller 166, the at least one airflow unit 126 of each of the plurality of DAC modules 118 to independently vary the exit direction D2 of the airflow 110, such that the exit direction D2 of the airflow 110 of the one DAC module 118 is different from the exit direction D2 of the airflow 110 of the other DAC module 118 of the plurality DAC modules 118. Such a variation in the exit speeds and/or the exit directions of the airflows 110 may create the large-scale flow structure and may promote the mixing of the airflows 110 exiting the plurality of DAC modules with the surrounding air.

In some embodiments, the at least one airflow unit 126 includes the fan 156 configured to operate at the fan speed and generate the airflow 110, and the diverter 158 configured to vary the exit direction D2 of the airflow 110. In some embodiments, the method 1200 further includes independently varying, via the controller 166, the fan speed of the fan 156 of the at least one airflow unit 126 of each DAC module 118 to vary the exit speed of the airflow 110, such that the fan speed of the fan 156 of the one DAC module 118 is different from the fan speed of the fan 156 of the at least one other DAC module 118. In some embodiments, the method 1200 further includes independently actuating, via the controller 166, the diverter 158 of the at least one airflow unit 126 of each DAC module 118 in order to vary the exit direction D2 of the airflow 110, such that the exit direction D2 of the airflow 110 of the one DAC module 118 is different from the exit direction D2 of the airflow 110 of the at least one other DAC module 118. The variation in the fan speed of the fan 156 of the DAC modules 118 may cause a variation in the exit speeds of the airflows 110 which may in turn create the large-scale flow structure and may promote the mixing of the airflows 110 exiting the plurality of DAC modules 118 with the surrounding air. Further, the actuation of the diverter 158 may cause variation in the exit directions of the airflows 110 which may in turn create the large-scale flow structure and may promote the mixing of the airflows 110 exiting the plurality of DAC modules 118 with the surrounding air.

The method 1200 further includes determining, via the at least one first sensor 168, the at least one wind parameter of the wind downstream of each DAC unit 102. The fan speed of the fan 156 of the at least one airflow unit 126 of each DAC module 118 is independently varied and/or the diverter 158 of the at least one airflow unit 126 of each DAC module 118 is independently actuated based on the at least one wind parameter. The determination of the at least one wind parameter by the first sensor 168 may be used to control the fan speed or actuate the diverter 158 in order to optimize the airflows 110 exiting the DAC modules 118 so as to promote the mixing of the airflows 110 with the surrounding air present downstream of the DAC unit 102.

Further, the method 1200 includes determining, via the at least one second sensor 170, the CO₂ concentration in the air upstream of the downstream DAC unit 104. The fan speed of the fan 156 of the at least one airflow unit 126 of each DAC module 118 is independently varied and/or the diverter 158 of the at least one airflow unit 126 of each DAC module 118 is independently actuated based on the CO₂ concentration. The determination of the CO₂ concentration in the air upstream of the downstream DAC unit 104 may allow the controller 166 to vary the fan speed and/or actuate the diverter 158 to promote the mixing of airflow 110 with the surrounding air. For example, if the CO₂ concentration is low, the exit speeds and the exit directions of the airflows 110 may have to be accordingly adjusted so that the CO₂ concentration in the air upstream of the downstream DAC unit 102 increases.

The method 1200 further includes mixing the airflows 110 exiting the plurality of DAC modules 118 by independently varying the fan speed of the fan 156 of the at least one airflow unit 126 of each DAC module 118 and/or independently actuating the diverter 158 of the at least one airflow unit 126 of each DAC module 118. The independent variation in the fan speeds and/or the independent actuation of the diverters 158 of the DAC modules 118 may create the large-scale flow structure which may promote the mixing of the airflows 110 exiting the plurality of DAC modules 118 with the surrounding air. The DAC system 100 and the method 1200 teaches the variation in the fan speed that may eventually cause the variation in the exit speeds of the airflows 110 that may create the large-scale flow structure and may promote the mixing of the airflows 110 exiting the plurality of DAC modules 118 with the surrounding air. Further, the actuation of the diverter 158 may eventually vary the exit direction D2 of the airflow 110 that may create the large-scale flow structure and may promote the mixing of the airflows 110 exiting the plurality of DAC modules 118 with the surrounding air.

To explain further, if the plume exhaust from one modules/array is ingested by a downstream module/array, it severely impacting its ability to absorber CO₂ in an efficient manner. This is especially prevalent for walls of absorber units as shown in FIG. 1, where the depleted exhaust plume can be strongly propagated into the inlet of another.

This problem is also an issue for modules/arrays arranged in arrays of individual modules or groups of modules, with inlets flowing parallel to the ground, and the exhaust being directed vertically.

The degree of mixing of the depleted plumes and subsequent reingestion, are a factor of relative air velocities and their direction of the exhaust and ambient airflow/wind. However, it is anticipated that the more mixing and dissipation the exhaust plume into the ambient air the better it is for the plant efficiency. To achieve this large vortical structures (eddies) of approximate same magnitude of size of each absorber array is required. To achieve this, deflection on the exhaust stream can be applied in a varying manner either across each module or across each array, optimised to deliver the most robust mixing under a wide range of conditions. The eddies may have a mixing length greater than half the spacing between DAC units. The eddies would preferably have a mixing length greater than the spacing between DAC units. The mixing length is related to the approximate diameter of the generated eddies, and indicates the height of the volume of air above the DAC units that is stirred into the DAC intake of a downstream unit to increase the amount of air undepleted of CO₂ available to the downstream unit.

One method as disclosed above would be to cant an exhaust cowling (See FIG. 5), or similar, away from the nominal centreline in a range between 0-45 degrees.

These angles can be selectively varied to induce large mixing structures within the airflow to attain the necessary mixing and dissipation. For example, a cross-flow wall type absorber could go from a uniform exit angle shown in to a mixed angle

This approach can be implemented on any configuration of absorber that has an exhaust plume. So can be applied on vertical exhausting arrays/modules in a similar way, where the exhaust could be that, but not limited to, from a set of fans venting a shared plenum or exhausts from dedicated fans affixed to each module. However, this is not limiting, to any arrangement or presence or lack of fans.

It will be understood that the invention is not limited to the embodiments above described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A direct air capture (DAC) system, comprising:
a plurality of DAC units spaced apart from each other, each DAC unit of the plurality of DAC units comprising at least one DAC module, the at least one DAC module comprising a housing, at least one absorber disposed within the housing, and at least one airflow unit mounted to the housing, wherein the at least one airflow unit generates an airflow that exits the at least one DAC module at an exit speed along an exit direction, and wherein the airflow flows towards a downstream DAC unit of the plurality of DAC units; and
a controller communicably coupled to the at least one airflow unit of the at least one DAC module, wherein the controller is configured to control the airflow exiting the at least one DAC module to generate one or more wind eddies from a surrounding air.

2. The DAC system of claim 1, wherein the controller is further configured to control the airflow to generate one or more wind eddies by:
independently varying the exit speed of the airflow, and/or varying the exit direction of the airflow.

3. The DAC system of claim 2, wherein the at least one DAC module includes a plurality of DAC modules disposed adjacent to each other, and wherein the controller is further configured to control the at least one airflow unit of each of the plurality of DAC modules to:
independently vary the exit speed of the airflow, such that the exit speed of the airflow of one DAC module of the plurality of DAC modules is different from the exit speed of the airflow of at least one other DAC module of the plurality DAC modules.

4. The DAC system of claim 2, wherein the controller is further configured to control the at least one airflow unit to:
vary the exit direction of the airflow of the at least one DAC module

5. The DAC system of claim 3, wherein the at least one airflow unit comprises a fan configured to operate at a fan speed and generate the airflow, and wherein the controller is further configured to:
independently vary the fan speed of the fan of the at least one airflow unit of each DAC module to vary the exit speed of the airflow, such that the fan speed of the fan of the one DAC module is different from the fan speed of the fan of the at least one other DAC module.

6. The DAC system of claim 4, wherein the at least one airflow unit comprises a diverter configured to vary the exit direction of the airflow and wherein the controller is further configured to:
independently actuate the diverter of the at least one airflow unit of each DAC module in order to vary the exit direction of the airflow.

7. The DAC system of claim 2, further comprising at least one first sensor communicably coupled to the controller and configured to determine at least one wind parameter of a wind downstream of each DAC unit, wherein the controller is further configured independently vary the exit speed of the airflow, and/or vary the exit direction of the airflow based on the at least one wind parameter.

8. The DAC system of claim 7, wherein the at least one wind parameter comprises a wind direction, a wind speed, and/or a wind pressure.

9. The DAC system of claim 7, wherein the at least one first sensor comprises an anemometer.

10. The DAC system of claim 7, further comprising at least one second sensor communicably coupled to the controller and configured to determine a carbon dioxide concentration in an air upstream of the downstream DAC unit, wherein the controller is further configured to independently vary the exit speed of the airflow, and/or vary the exit direction of the airflow based on the carbon dioxide concentration.

11. The DAC system of claim 6, wherein the diverter comprises a louver, and wherein the controller is further configured to move the louver in order to vary the exit direction of the airflow.

12. The DAC system of claim 6, wherein the diverter comprises a cowl of the fan, and wherein the controller is further configured to move the cowl of the fan in order to vary the exit direction of the airflow.

13. The DAC system of claim 1, wherein the at least one DAC module includes a plurality of DAC modules, and wherein the plurality of DAC modules of each DAC unit are arranged in an array comprising a plurality of rows and a plurality of columns.

14. The DAC system of claim 1, wherein the controller is configured to control the airflow exiting the at least one DAC module to generate the one or more wind eddies on a scale of a spacing between two adjacent DAC units from the plurality of DAC units

15. The DAC system of claim 3, wherein the plurality of DAC modules are coplanar with each other.

16. The DAC system of claim 3, wherein at least two of the plurality of DAC modules are inclined to each other.

17. The DAC system of claim 3, wherein at least two of the plurality of DAC modules define a gap between each other.

18. The DAC system of claim 3, wherein the plurality of DAC modules are arranged in a staggered arrangement.

19. The DAC system of claim 3, wherein at least two of the plurality of DAC modules have different heights.

20. A method, comprising:
providing a plurality of DAC units spaced apart from each other, each DAC unit of the plurality of DAC units comprising at least one DAC module, the at least one DAC module comprising a housing, at least one absorber disposed within the housing, and at least one airflow unit mounted to the housing, wherein the at least one airflow unit generates an airflow that exits the at least one DAC module at an exit speed along an exit direction, and wherein the airflow flows towards a downstream DAC unit of the plurality of DAC units; and
controlling, via the controller, the airflow exiting the at least one DAC module to generate one or more wind eddies from a surrounding air.

21. The method of claim 20, wherein the at least one DAC module comprises a plurality of DAC modules disposed adjacent to each other, the method further comprising controlling, by the controller, the at least one airflow unit of each of the plurality of DAC modules to:
independently vary the exit speed of the airflow, such that the exit speed of the airflow of one DAC module of the plurality of DAC modules is different from the exit speed of the airflow of at least one other DAC module of the plurality DAC modules; and/or
independently vary the exit direction of the airflow, such that the exit direction of the airflow of the one DAC module, is different from the exit direction of the airflow of the other DAC module, of the plurality DAC modules.

22. The method of claim 21, wherein the at least one airflow unit comprises a fan configured to operate at a fan speed and generate the airflow, and a diverter configured to vary the exit direction of the airflow, the method further comprising:
independently varying, via the controller, the fan speed of the fan of the at least one airflow unit (of each DAC module to vary the exit speed of the airflow, such that the fan speed of the fan of the one DAC module is different from the fan speed of the fan least one other DAC module and/or
independently actuating, via the controller, the diverter of the at least one airflow unit of each DAC module in order to vary the exit direction of the airflow, such that the exit direction of the airflow of the one DAC module is different from the exit direction of the airflow of the at least one other DAC module.

23. The method of claim 22, further comprising determining, via at least one first sensor, at least one wind parameter of a wind downstream of each DAC unit, wherein the fan speed of the fan of the at least one airflow unit of each DAC module is independently varied and/or the diverter of the at least one airflow unit of each DAC module is independently actuated based on the at least one wind parameter.

24. The method of claim 22, further comprising determining, via at least one second sensor, a carbon dioxide concentration in an air upstream of the downstream DAC unit, wherein the fan speed of the fan of the at least one airflow unit of each DAC module is independently varied and/or the diverter of the at least one airflow unit of each DAC module is independently actuated based on the carbon dioxide concentration.

25. The method of claim 21, further comprising mixing the airflows exiting the plurality of DAC modules by independently varying the fan speed of the fan of the at least one airflow unit of each DAC module and/or independently actuating the diverter of the at least one airflow unit of each DAC module.
